(19) United States
(12) Patent Application Publication
(10) Pub. No.: US 2021/0063719 A1
(43) Pub. Date: Mar. 4, 2021

(54) Universal Microscope Stage

(71) Applicant: IPAI, Inc., Baytown, TX (US)

(72) Inventors: Michael Al Oudat, Baytown, TX (US); Islam Shdaifat, Hamburg (DE); Sarah Ibrahim Alshdaifat, Kingston (CA)

(21) Appl. No.: 16/559,083

(22) Filed: Sep. 3, 2019

(51) Int. Cl. G02B 21/26; G02B 21/34; G02B 21/36

(52) U.S. Cl. CPC G02B 21/26; G02B 21/002; G02B 21/362; G02B 21/34

(57) ABSTRACT

A universal microscope stage is described herein. The universal microscope stage can comprise a slide holder, a base mount, a first rack, a first driver, and a first pinion. The slide holder can be capable of holding a slide in a fixed position relative to the slide holder. The base can comprise a plurality of mounting orifices aligned across the base mount. The first rack can be mounted to the base mount. The first driver can comprise a first pinion orifice. The first pinion can extend through the first pinion orifice. The first pinion can interface with the first rack such that when the first pinion rotates, the first driver can move the slide holder along a first axis relative to the base mount.

### BACKGROUND

This disclosure relates to a universal microscope stage. This disclosure also relates to a universal slide scanner and method of use thereof. Further, this disclosure also relates to a system and method for scanning. Additionally, this disclosure relates to a mobile device mount connectable to a microscope and a method of use thereof. Finally, this disclosure relates to a system and method for using machine learning to train a model to scan and analyze biological samples using a microscope.

Microscopes are used to magnify samples typically held on glass slides. These slides are held in place on the microscope's stage. Traditionally, microscope stages are moveable in the dimensions using different knobs. Moving the stage allows a user to magnify different areas of the sample. Additionally, microscope stages have traditionally only fit on a particular model of microscope. Typically, the number and location of mounting holes differ between microscope models. Thus, stages are not interchangeable. Additionally, most stages require a user to directly interface with the microscope. As such, it would be useful to have a universal microscope stage.

Traditionally, users had to be present to view samples on microscope slides. The user had to control the microscope stage, and there was no way to capture images from these slides to be viewed at a later date or remotely. Overtime, systems and methods were developed that allowed for microscope slides to be digitized however there were no systems to convert a traditional microscope into one that could digitize slides. Further, there was no system or method that would allow a user to control the digitization of microscope slides remotely using a traditional microscope. As such, it would be useful to have a universal microscope scanner that would allow users to adapt any microscope to be able to digitize slides.

In the past, scanning systems have required computing systems such as desktops and laptops as well as an external camera. Initially, these computing systems are large, were difficult to transport, and required external power sources. As computing technology has evolved, mobile devices such as tablets and smart phones have brought significant computing power into smaller and smaller objects. Further, many smart devices feature integral camera. However, a system or method to use these integral cameras to capture images of samples using microscope slides has not been developed. As such, it would be useful if a user could mount a mobile device to a microscope and use the mobile device's camera to digitize a slide.

The analysis of biological samples has traditionally required extensive training. In fact, typically these analyses of medical samples require a pathologist. A skilled pathologist can recognize areas of concern, focus a microscope on these areas and use the information gathered to diagnose diseases. Traditionally, this analysis is done manually, in person by the pathologist. The development of digital imaging technology allowed some analysis to be done remotely, however if the pathologist required more information about an area of interest then additional scanning and imaging would be required. As such, it would be useful to have an improved system and method to use machine learning to train a model to scan and analyze biological samples using a microscope.

### SUMMARY

A universal microscope stage is disclosed. The universal microscope stage can comprise a slide holder, a base mount, a first rack, a first driver, and a first pinion. The slide holder can be capable of holding a slide in a fixed position relative to the slide holder. The base can comprise a plurality of mounting orifices aligned across the base mount. The first rack can be mounted to the base mount. The first driver can comprise a first pinion orifice. The first pinion can extend through the first pinion orifice. The first pinion can interface with the first rack such that when the first pinion rotates, the first driver can move the slide holder along a first axis relative to the base mount.

Another embodiment of a universal microscope stage is also disclosed. On one embodiment, a universal microscope stage can comprise a slide holder, a base mount, a first rack, a first driver, and a first pinion. The slide holder can be capable of holding a slide in a fixed position relative to the slide holder. The base mount can comprise a proximal base mount end, a distal base mount end, and a mounting orifice. The mounting orifice can greatly extend from the proximal base mount end to the distal base mount end. The first rack can be mounted to the base mount. The first driver can comprise a first pinion orifice. The first pinion can extend through the first pinion orifice. The first pinion can interface with the first rack such that when the first pinion rotates, the first driver can move the slide holder along a first axis relative to the base mount.

Also, a universal microscope scanner is disclosed. The universal microscope scanner can comprise a first motor assembly, a second motor assembly, a controller, a controller processor, and a camera. The first motor assembly can be connectable to and removable from a first pinion of a stage such that the first motor assembly can be capable of moving a slide holder along a first axis. The first motor assembly can be exterior to the stage. The second motor assembly can be connectable to and removable from a second pinion of a stage such that the second motor assembly can be capable of moving the slide holder along a second axis. The second motor assembly can be exterior to the stage. The controller can comprise a controller local interface, a controller network interface, and a controller memory. The controller memory can comprise a controller application and a controller datastore. The controller processor in accordance with program instructions from the controller application can receive motor instructions over the controller network interface from a computer. Moreover, the controller processor in accordance with program instructions from the controller application can control the first motor and the second motor based on the motor instructions. The camera can be mounted on a microscope such that the camera can be capable of capturing images of a slide.

A method for scanning slides is also disclosed. The method for scanning slides can comprise the step of performing a first scan by capturing one or more initial images of a plurality of images of a slide with a camera at a starting point. Performing the first scan can also comprise the step of continuing in repeated steps until reaching an end point the substeps of capturing one or more additional images of a plurality of images at each of a plurality of intermittent points across the slide a long a first axis of a stage by adjusting the first axis of the stage, until the camera detects a boundary using imaging processing. The first axis need not be parallel to the boundary. Additionally, the substeps can comprise moving, upon reaching the boundary, the stage parallel to the boundary a predetermined distance. Lastly, performing the first scan can comprise the step of combining the plurality of images to create one or more composite images.

Further, a system for scanning slides is disclosed. The system for scanning slides can comprise a controllable stage, a camera, and a computer. The computer can comprise a network interface and a computer memory. The computer memory can comprise a computer application and a computer processor. The computer processor, in accordance with program instructions from the computer application can perform a first scan by capturing one or more initial images of a plurality of images of a slide with the camera at a starting point. Performing a first scan can also comprise the step of continuing in repeated steps until reaching an end point the subsets of capturing one or more additional images of a plurality of images at each of a plurality of intermittent points across the slide along a first axis of the controllable stage by adjusting the first axis of the controllable stage, until the camera detects a boundary using imaging processing. The first axis cannot be parallel to the boundary. Additionally, the substeps can comprise moving, upon reaching the boundary, the controllable stage parallel to the boundary a predetermined distance. Lastly, performing the first scan can comprise the step of combining the plurality of images to create one or more composite images.

Also, a mobile device mount connectable to a microscope is disclosed. The mobile device mount can comprise a platform, a mounting bracket, and a clamping device. The platform can comprise a proximal end, a distal end, a top surface, a bottom surface, and an opening located at the proximal end. The top surface can be fitted with a camera. The top surface can be capable of supporting a mobile device. The opening can extend from the top surface through to the bottom surface. The mounting bracket can be slidably operable within the opening. The clamping device can be capable of fixing the mounting bracket to an eyepiece of a microscope such that the eyepiece is fixed within the opening such that the camera of the mobile device, when resting on the top surface, can be capable of capturing images displayed by the eyepiece.

A method for capturing images of a microscope slide using a mobile device mount is also disclosed. The method can comprise the step of affixing a mobile device mount to an eyepiece of a microscope. The mobile device mount can comprise a platform, a mounting bracket, and a clamping device. The platform can comprise a proximal end, a distal end, a top surface, a bottom surface and an opening located at the proximal end. The top surface can be capable of supporting the mobile device, the mobile device can be fitted with a camera. The opening can extend from the top surface through to the bottom surface. The mounting bracket can be slidably operable within the opening. The clamping device can affix the mounting bracket to the eyepiece such that the eyepiece can be fixed within the opening. Furthermore, the method can comprise the steps of placing the mobile device on the platform and capturing an image displayed through the eyepiece of a sample using the camera. The camera can be over the eyepiece.

Further, a method for training a model to automatically scan a sample is disclosed. The method can comprise the steps of performing a fast scan for each sample of a plurality of samples using a microscope scanner and receiving manual inputs from an operator. The manual inputs can direct a microscope to one or more areas of interest for each of the sample. The method can also comprise the steps of recording for each of the area of interest a plurality of attributes of the area of interest, receiving scan parameters from the operator, and training a slide scanning model to match the attributes with the scan parameters.

Lastly, a system for automatically scanning a sample is disclosed. The system can comprise a microscope scanner and a computer. The computer can comprise a computer network interface, a computer memory, and a computer processor. The computer memory can comprise a computer application. The computer processor in accordance with program instructions from the computer application can perform a fast scan for each sample of a plurality of samples using the microscope scanner and can receive manual inputs from an operator. The manual inputs can direct a microscope to one or more areas of interest for each of the sample. Additionally, the computer processor in accordance with program instructions from the computer application can record for each of the area of interest a plurality of attributes of the area of interest, can receive scan parameters from the operator, and can train a slide scanning model to match the attributes with the scan parameters.

### BRIEF DESCRIPTION OF THE DRAWINGS

FIG. 1A illustrates an exemplary configuration of a universal microscope stage.

FIG. 1B illustrates another exemplary configuration of a universal microscope stage.

FIG. 2A illustrates a universal microscope stage with a first motor assembly and a second motor assembly.

FIG. 2B illustrates an exploded view of a universal microscope stage with a first motor assembly and a second motor assembly.

FIG. 2C illustrates an elevation view of a universal microscope stage with a first motor assembly and a second motor assembly.

FIG. 3A illustrates a universal microscope stage installed on a standard microscope.

FIG. 3B illustrates a third motor assembly installed on a microscope.

FIG. 3C illustrates an additional view of third motor assembly installed on a microscope.

FIG. 3D illustrates an installation of a universal microscope scanner.

FIG. 3E illustrates a focus knob adaptor.

FIG. 4 illustrates a schematic block diagram of a controller

FIG. 5 illustrates a computer.

FIG. 6 illustrates an exemplary configuration of a universal microscope scanner, with a computer.

FIG. 7 illustrates a scanning path on a microscope slide.

FIG. 8 illustrates a fast scanning method flowchart.

FIG. 9 illustrates an optimal mechanical scanning path.

FIG. 10 illustrates a detailed scanning flowchart.

FIG. 11 illustrates a graphical user interface configured to control a universal microscope scanner and display real time images of a sample.

FIG. 12 illustrates a mobile device mount.

FIG. 13 illustrates a mobile device mount installed on a standard microscope.

FIG. 14A illustrates a mobile device.

FIG. 14B illustrates a mobile device being used with a mobile device mount installed on a standard microscope.

FIG. 15A illustrates an exemplary computer data store.

FIG. 15B illustrates training a model.

FIG. 15C illustrates feeding inputs into a model.

FIG. 16 illustrates initial parameters.

FIG. 17 illustrates model attributes.

FIG. 18 illustrates an exemplary method for automating microscope scanning of samples.

FIG. 19 illustrates a step, obtaining suitable sets of user inputs to be used for training a model used automate microscope scanning of samples.

FIG. 20 illustrates a model processing subsequent fast scan images to produce subsequent parameters and scanner outputs.

### DETAILED DESCRIPTION

Described herein is a system and method for a universal microscope stage. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

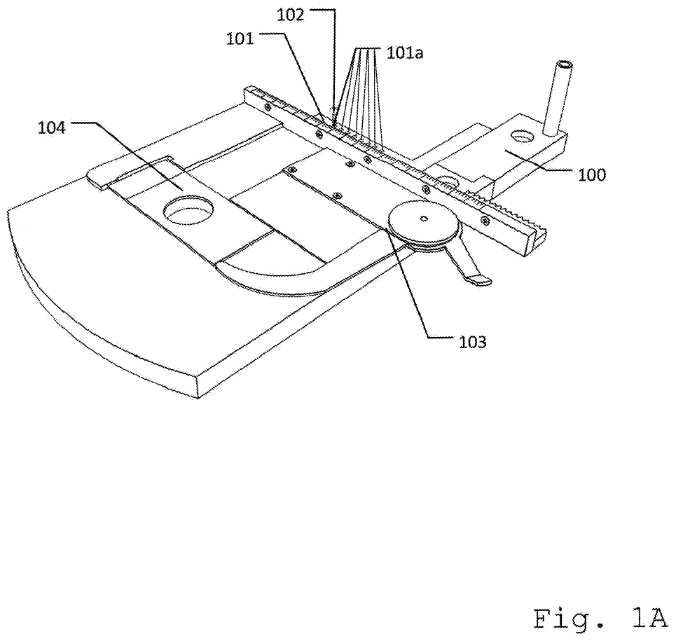

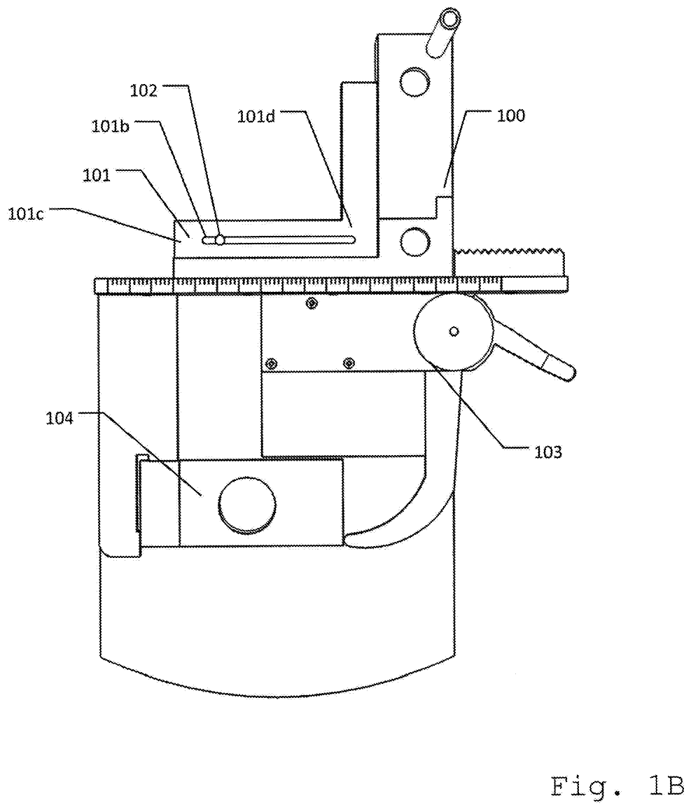

FIG. 1A illustrates a illustrates an exemplary configuration of a universal microscope stage 100. In one embodiment, universal microscope stage 100 can comprise a base mount 101, a mounting bolt 102, slide holder 103, and a slide 104. In one embodiment, base mount 101 can comprise comprised of a plurality of mounting orifices 101a.

Each mounting orifice 101a on base mount 101 allows universal scanner state 100 to be positioned on a microscope and mounted using mounting bolt 102. Slide holder 103 holds slide 104 in place for viewing.

FIG. 1B illustrates another exemplary configuration of a universal microscope stage 100. In one embodiment, universal microscope stage 100 can comprise base mount 101, a mounting bolt 102, slide holder 103, and a slide 104. Base mount 101 can further comprise a first side 101c and a second side 101d. In one embodiment, base mount 101 is further comprised of orifice 101b. Orifice 101b can be a single long orifice which runs between first side 101c and second side 101d.

Orifice 101b on base mount 101 allows universal microscope stage 100 to be positioned on a microscope and mounted using mounting bolt 102. Mounting bolt 102 can slide along orifice 101b. Mounting bolt 102 can be tightened at any point along orifice 101b.

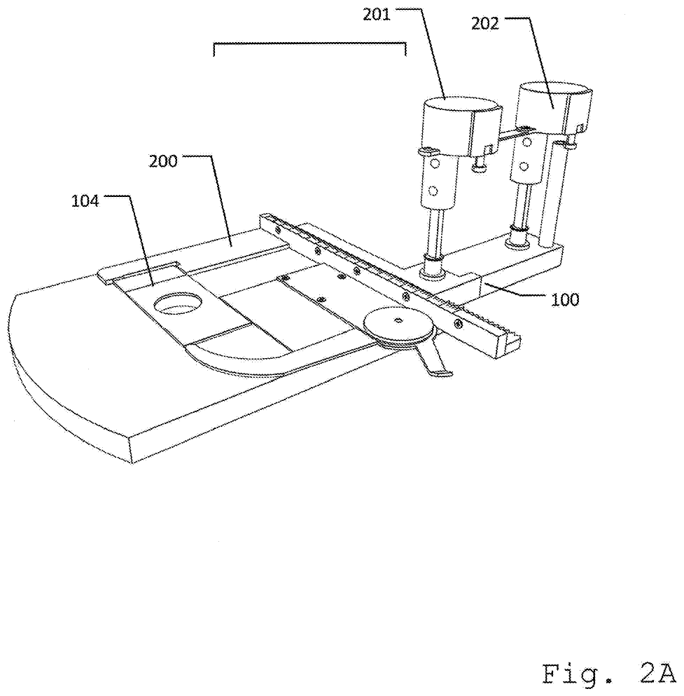

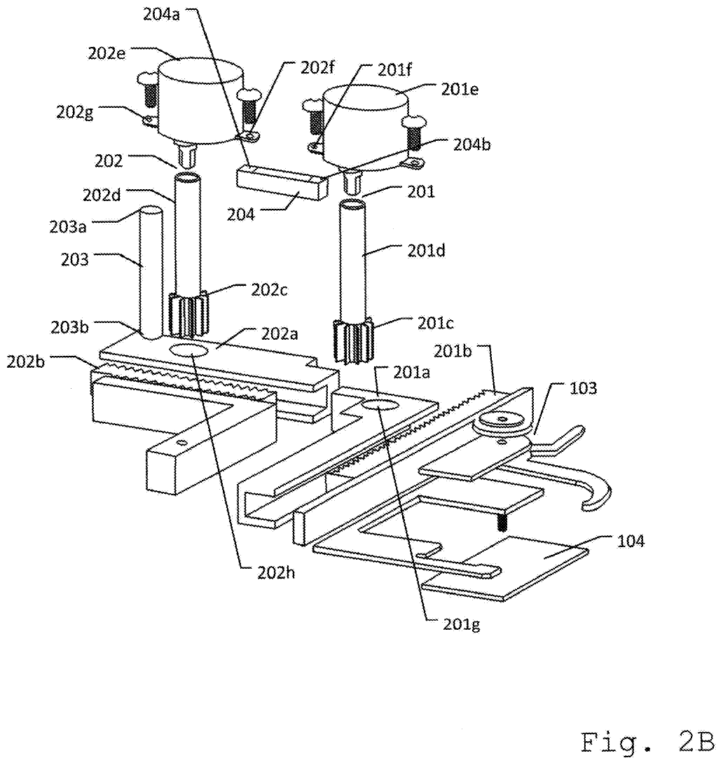

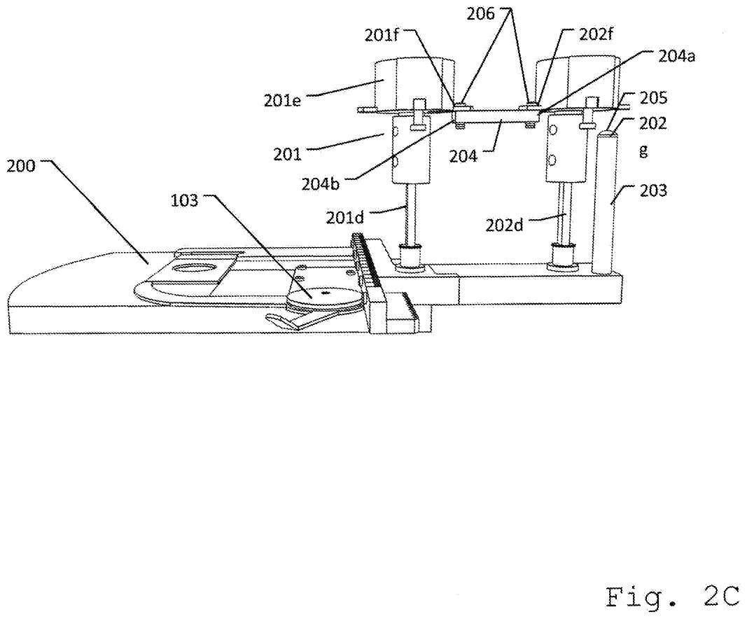

FIG. 2A illustrates a universal scanning stage 200. Universal scanning stage 200 can be comprised of microscope stage 100 with a first motor assembly 201 and a second motor assembly 202. In one embodiment, first motor assembly 201 can be inserted into universal microscope stage 100. First motor assembly 201 can rotate causing slide 104 to move in the x-axis. second motor assembly 202 can be inserted into universal microscope stage 100. second motor assembly 202 can rotate causing slide 104 to move in the y-axis.

FIG. 2B illustrates an exploded view of universal microscope stage 100 with first motor assembly 201 and second motor assembly 202. In one embodiment, first motor assembly 201 can be comprised of a first driver 201a, a first rack 201b, a first pinion gear 201c, a first axis shaft 201d, a first axis motor 201e, a first motor mounting point 201f and a first pinion orifice 202g. second motor assembly 202 can be comprised of a second driver 202a, a second rack 202b, a second pinion gear 202c, a second axis shaft 202d, a second axis motor 202e, a first second motor mounting point 202f, a second motor mounting point 202g, and a second axis pinon orifice 202h. first motor assembly 201 moves slide holder 103 and slide 104 in the first axis. second motor assembly 202 moves slide holder 103 and slide 104 in the y-axis. Second motor 202e is connected to a motor mount 203. Motor mount 203 can further comprise a motor mount proximal end 203a and a motor mount distal end 203b. Motor mount proximal end 203a can be used to connect to second motor 202e. Motor mount distal end 203b can be connected to second driver 202a. A bracket 204 connects second motor 202e and first motor 201e together. Bracket 204 can further comprise a bracket proximal end 204a and a bracket distal end 204b.

FIG. 2C illustrates an elevation view of universal microscope stage 100 with first motor assembly 201 and second motor assembly 202. In one embodiment, second motor 202e can be anchored to motor mount 203 using motor mounting screw 205 through a first second motor mounting point 202f Without this connection, second motor 202e would be unable to rotate second axis shaft 202d. Instead, second motor 202e would rotate freely and be unable to move slide holder 103. In one embodiment, second motor 202e can be connected to first motor 201e using bracket 204. Bracket 204 can be connected to first motor 201e and second motor 202e using a plurality of screws 206. A first screw 206 can connect bracket 204 to first motor 201e through a first motor mounting point 202f and bracket proximal end 204b. A second screw 206 can connect bracket 204 to second motor 202e through second motor mounting point 202f and bracket distal end 204b. Without this connection first motor 201e would be unable to rotate first shaft 201d. Instead, first motor 201e would rotate freely and be unable to move slide holder 103.

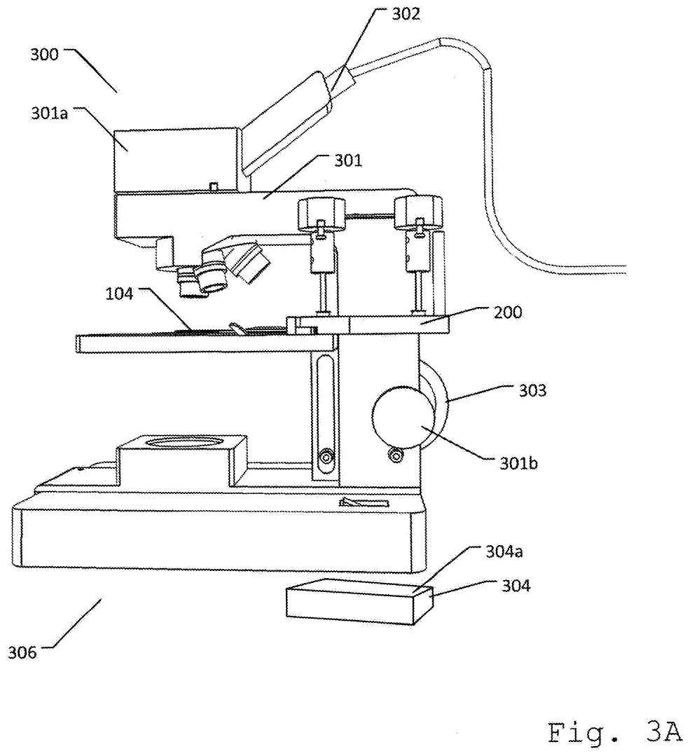

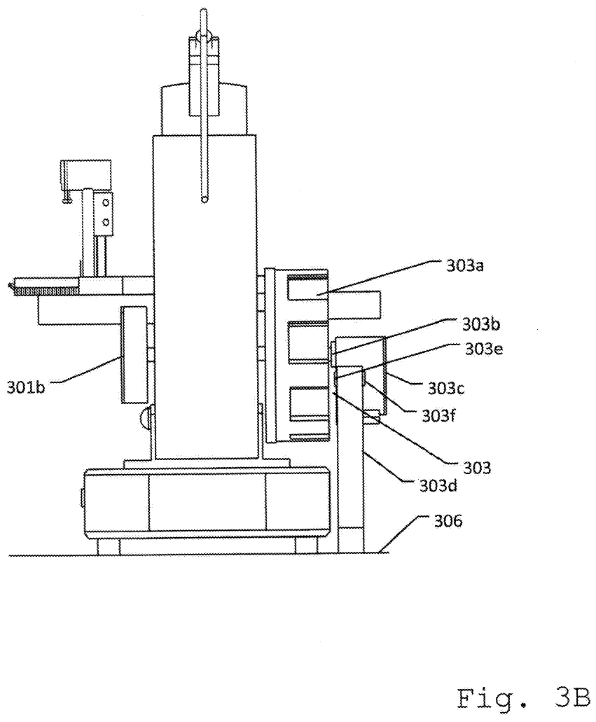

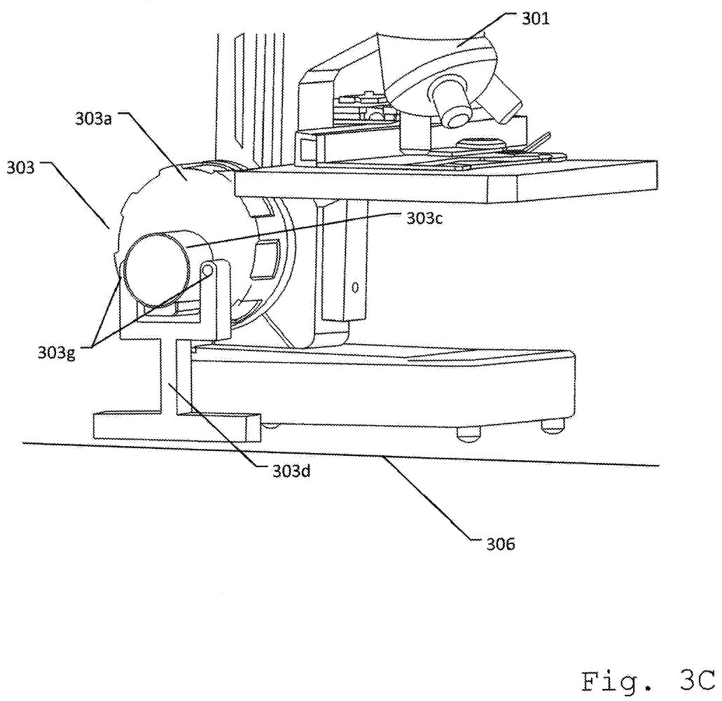

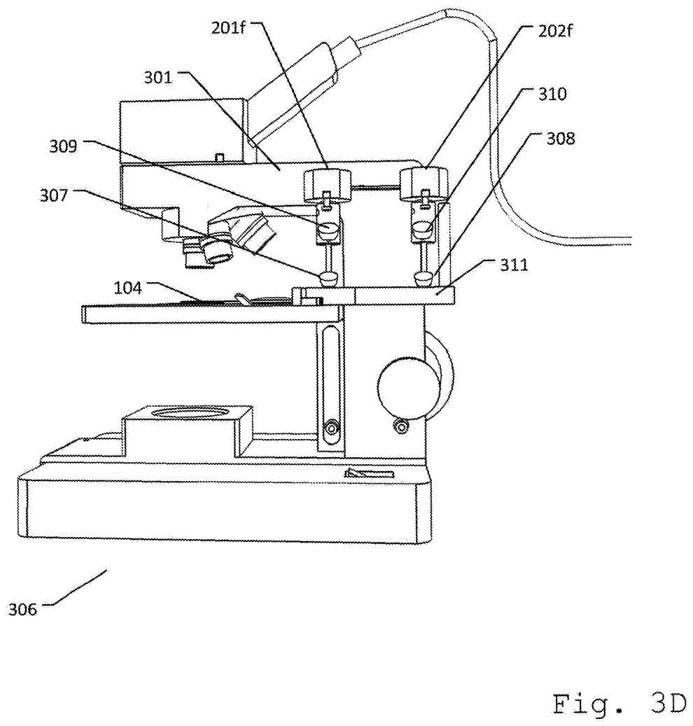

FIG. 3A illustrates a standard microscope with a universal slide scanner installed 300. In one embodiment, standard microscope with the universal slide scanner installed 300 can comprise a standard microscope 301, a camera 302, a universal microscope stage 100, a third motor assembly 303, a controller 304, a computer 305 and a surface 306. Standard microscope 301 can further comprise eyepiece 301a and focus knob 301b. Camera 302 can be mounted to eyepiece 301a and can be used to capture images of slide 104. Third motor assembly 303 can be mounted to focus knob 301b. Third motor assembly 303 can move universal microscope stage 100 in the z-axis. First motor assembly 201, second motor assembly 202, and third motor assembly 303c can be operated by controller 304. Controller 304 can be given instructions by computer 305. In one embodiment, controller 304 can be housed in controller enclosure 304a. Further, in one embodiment, computer 305 can be a mobile device such as a smart phone or tablet. Finally, in one embodiment the magnification of microscope 301 can be changed by mechanical means.

FIG. 3B illustrates third motor assembly 303 installed on microscope 301. In one embodiment, third motor assembly 303 can be comprised of focus knob adapter 303a, third axis shaft 303b, third motor 303c, anchor 303d and one or more third motor mounts 303e. Third axis shaft 303b can be connected to focus knob 301b using focus knob adapter 303a. Third axis shaft 303b can be connected to third motor 303c and can turn focus knob 301b to move universal microscope stage 100 in the third axis. Third motor 303c can be connected to anchor 303d using one or more anchor screws 303f through motor mounts 303g. Anchor 303d can rest on surface 306 upon which standard microscope 301 is resting. Anchor 303d prevents third motor 303c from spinning freely.

FIG. 3C illustrates another view of third motor assembly 303 installed on standard microscope 301. In one embodiment, third axis motor 303c can be connected to focus knob adaptor 303a. Additionally, third axis motor can be connected to anchor 303d using anchor screws 303f installed through third motor mounts 303g. Anchor 303d and microscope 301 can be resting on surface 306. The connection between third axis motor 303c and anchor 303d prevents motor 303c from rotating freely and thus can allow it to turn focus knob adaptor 303a.

FIG. 3D illustrates an installation of a universal microscope scanner using a stock microscope stage 311. Stock microscope stage 311 can be further comprised of first axis knob 307 and second axis knob 308. First axis knob 307 can be used to move slide 104 in the x-axis. Second axis knob 308 can be used to move slide 104 in the y-axis. In one embodiment, first motor 201f can be coupled to a first-axis knob adaptor 309. Further, first axis knob adaptor 309 can connect to first axis knob 307, which can allow first motor 201f to turn first axis knob 307 and move slide 104. second motor 202f can be coupled to a second axis knob adaptor 310. Additionally, second axis knob adaptor 310 can connect to second axis knob 308, which can allow second motor 202f to turn second axis knob 308 and move slide 104.

FIG. 3E illustrates a focus knob adaptor 303A. Focus knob adaptor 303A can be comprised of an adapter base 312 and a plurality of fingers 313. In one embodiment, the spacing of fingers 313 inside of adapter base 312 can be adjusted to fit any size of focus knob 301b.

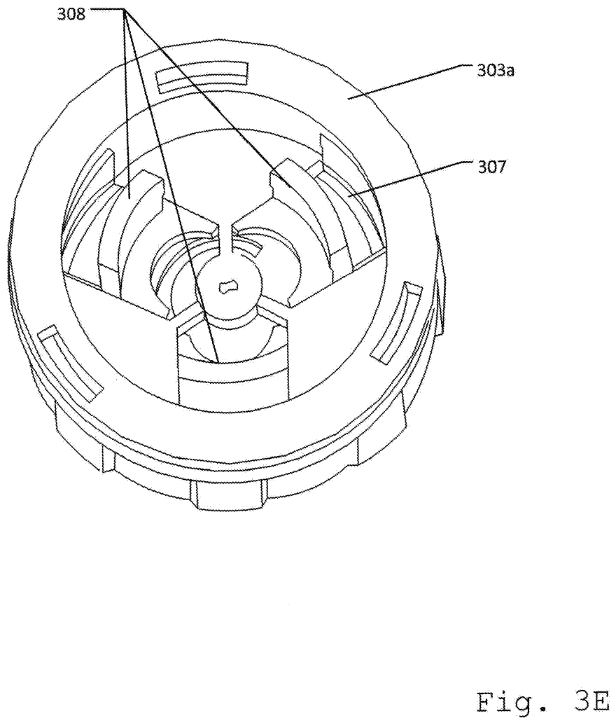

FIG. 4 illustrates a schematic block diagram of a controller 304. In one embodiment, controller 304 can have one or more controller processors 401 and a controller memory 402. Controller processor 401 and controller memory 402 can be coupled a controller local interface 405 and a controller remote interface 406. Controller local interface 404 can comprise, for example a data bus with an accompanying address/control bus or other bus structure as can be appreciated. Controller remote interface 406 can comprise hardware to control stage motors, receive data from imaging devices and receive instructions from computer 305.

Stored in controller memory 402 are both data and several components that are executable by controller processor 402. Controller application 403 can be stored in controller memory 402 and can be executable by controller processor 401. Other applications could potentially be stored in memory 402. Also, stored in memory 402 can be a datastore 404 along with other data.

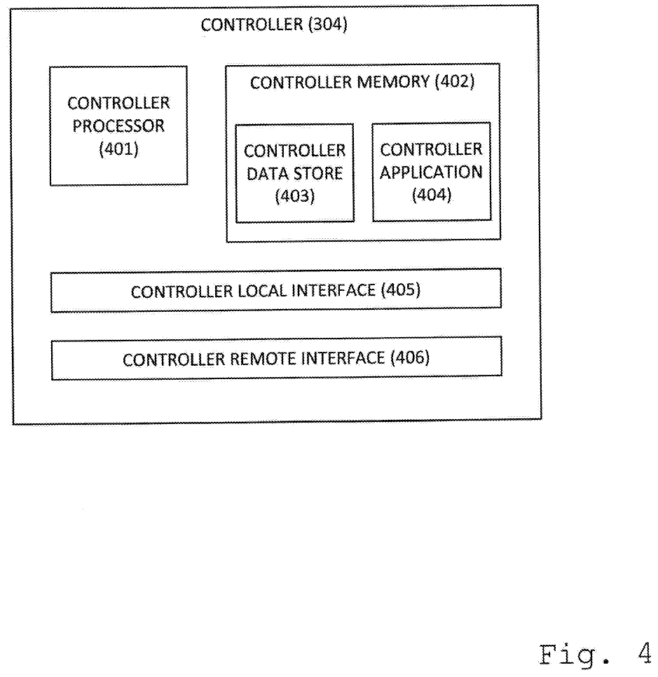

FIG. 5 illustrates a computer 305. In one embodiment, computer 305 can be comprised of computer processor 501, computer memory 502, a computer local interface 503, and a computer remote interface 504. Computer memory 502 can be comprised of a computer datastore 504 and a computer application 505. Computer application 505 can be stored in computer memory 502. Computer application 505 can provide instructions to computer processor 501. Computer processor 501 interprets instructions from computer application 505 and uses these instructions to control external devices. A user can provide commands to computer 305 via computer local interface 503 or computer network interface 504.

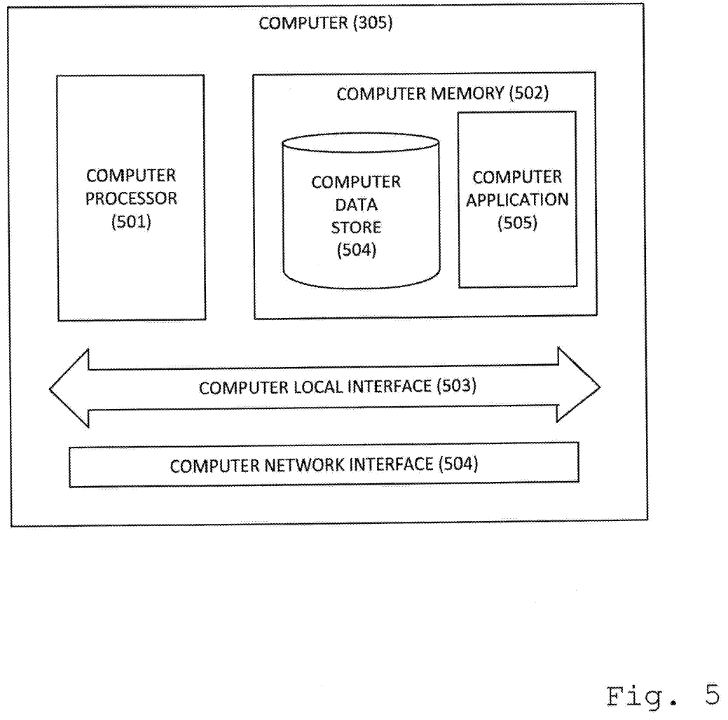

FIG. 6 illustrates an exemplary configuration of standard microscope with a universal slide scanner installed 300, with a computer 305 using controller 304. Computer 305 can comprise drivers or other specialized software to interface with controller 304. Examples of computer 305 can include, but are not limited to, a desktop computer, laptop, tablet, or smart device. In such an embodiment, image data captured by camera 302 can be viewed, recorded, controlled, and/or stored within computer 305.

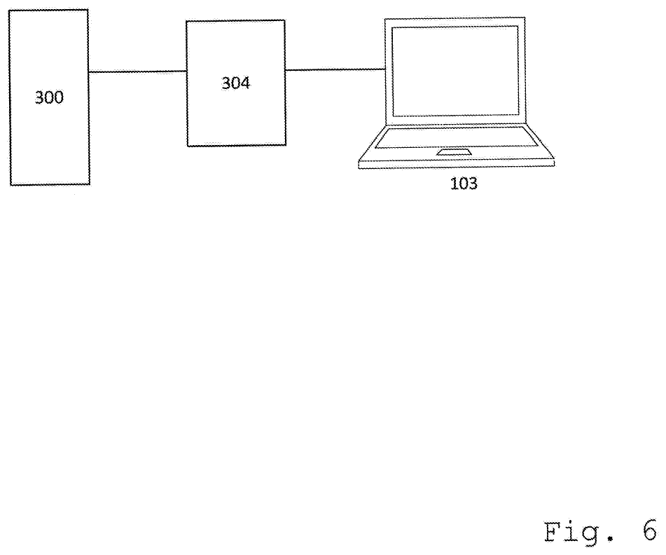

FIG. 7 illustrates slide 104. Slide 104 contains a slide boundary 701, a slide start 702, a slide scanning path 703, a slide end 704, a sample 705, a first calibration image 706, a second calibration image 707, a third calibration image 708, a maximum y-step 709, a minimum y-overlap 710, a maximum x-step 711, and a minimum x-overlap 712.

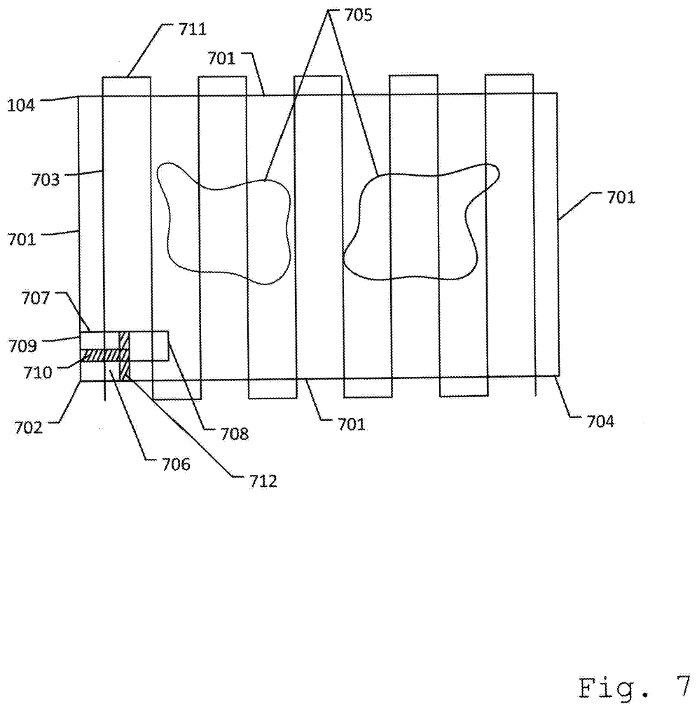

FIG. 8 illustrates a fast scanning method block diagram 800. A start fast scan command 801 instructs computer application 505 to begin the fast scan. Locate slide start 802 can move slide 104 to a slide start 802. In one embodiment, slide start 702 can be the lower right corner of slide 104. Next, calibrate scanner 803 can calibrate the scanner by moving slide 104 to slide start 702. Camera 302 captures first calibration image 706. Slide 104 then moves up the y-axis a small amount along slide scanning path 703 and a second calibration image 707 can be captured by camera 302. In one embodiment, Computer application 505 analyzes first calibration image 706 and second calibration image 707 and determines if images contain minimum y-overlap 710 to enable first calibration image 706 and second calibration image 707 can be combined into a single image. The distance moved along the y-axis can be the maximum y-step 709. Slide 104 can the moves up the x-axis a small distance along slide scanning path 703 and third calibration image 708 can be taken. Third calibration image 708 can be adjacent to second calibration image 707. Computer application 505 analyzes second calibration image 707 and third calibration image 708 can determine if images contain a minimum x-overlap 712 to enable second calibration image 707 and third calibration image 708 to be combined into a single image. The distance moved along the x-axis can be a maximum x-step 711.

Begin fast scan full slide 804 moves slide 104 to slide start 702 in order to develop an image of the entirety of slide 104. Capture image and record location 805 captures an image using camera 302 and image location and then records them in computer datastore 504. Move along scanning path by maximum y-step 806 moves slide 104 along the y-axis following slide scanning path 703 by maximum y-step 709. Capture image and record location 807 captures an image using camera 302 and image location and then records them in computer datastore 504. Step 808 determines if microscope slide has moved to slide boundary 701. If slide boundary 701 has not been reached, steps 806 through 808 are repeated until slide boundary 701 is reached. Step 809 verifies if slide end 704 has been reached. If slide end 704 has been reached, create composite image 811 combines all previous images together to form one composite image. If step 809 determines that slide end 704 has not been reached, then move along scanning path by maximum x-step 711 can move slide 104 along the x-axis following slide scanning path 703 by maximum x-step 711. Capture image and record location 807 captures an image using camera 302 and image location and then records them in computer datastore 504. The above steps will be repeated until slide end 704 is reached.

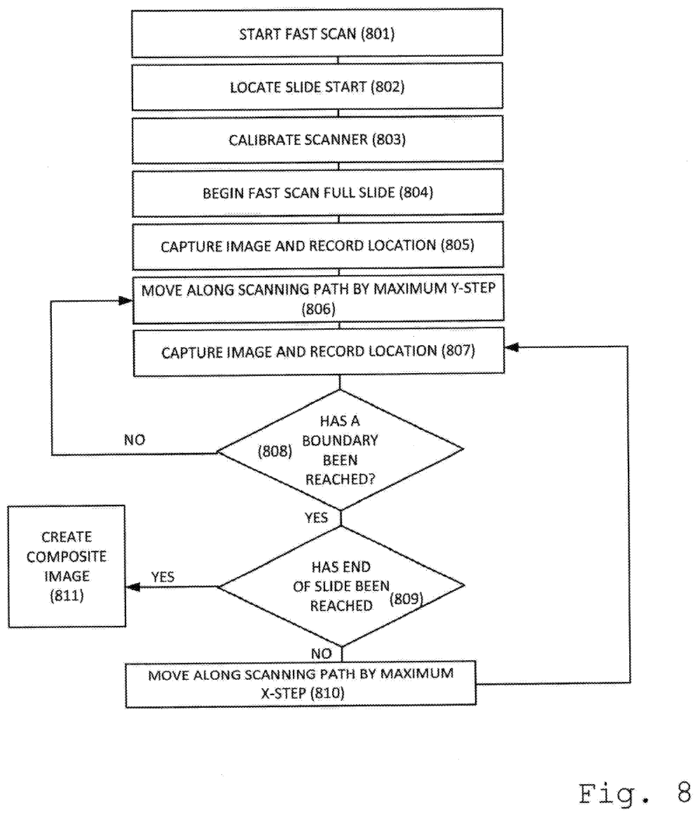

FIG. 9 illustrates an optimal scan path 900 in two different scenarios. Optimal scan path 900 can be the shortest zig-zag path. In a first scenario 901, a first camera axis 902 and a first slide axis 903 are aligned. First scenario 901 can result in a first scenario scan path 904 where slide 104 moves in only the x or y direction. First scenario 901 can result in a first angle 905 being ninety degrees. However, in a second scenario 906 where a second camera axis 907 and a second slide axis 908 are not aligned, slide 104 can move a small mount in both the x and y directions simultaneously. This results in an optimal scanning path 909 where a second angle 910 cannot be ninety degrees. Optimal scanning path 909 can reduce any image alignment error by scanning along camera axis 907 and can move a maximum scanning path step 911. Column step 912 can be parallel to slide axis 908.

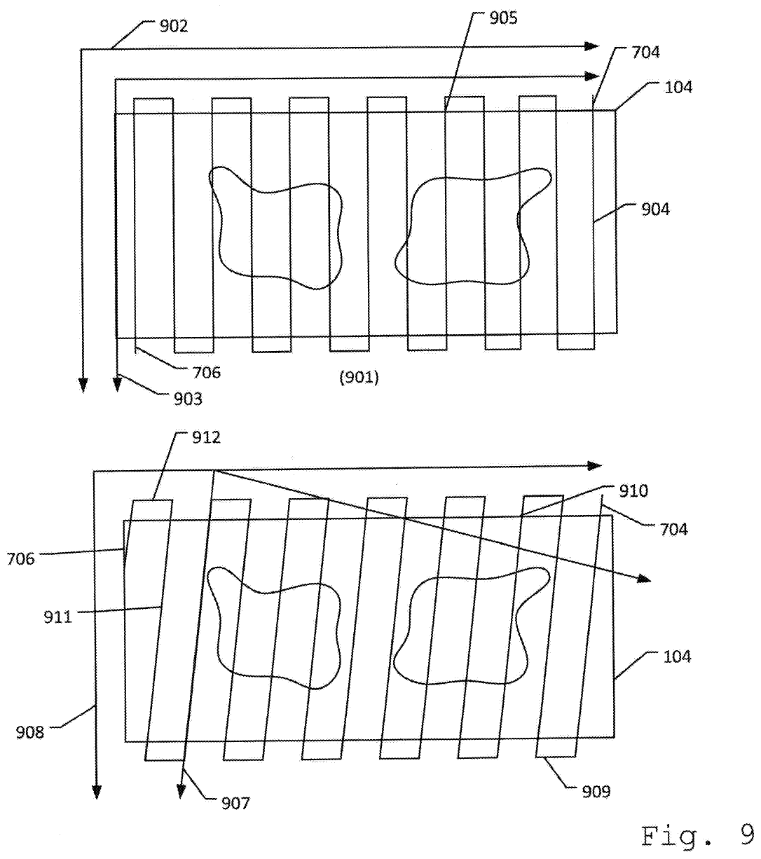

FIG. 10 illustrates a detailed scanning block diagram. Begin detail scan 1001 instructs computer application 505 to begin the detail scanning process. Move to slide start 1002 moves slide 104 to slide start 702. Capture Image 1003 captures an image of slide 104. Calibrate scanner step 1004 compares the image captured by capture image 1003 to adjacent images and/or slide boundaries. Calibrate scanner step 1004 will then adjust the length of maximum scanning path Step 911 to ensure that there will be sufficient overlap between subsequently captured images. Fix focus plane 1005 uses third motor assembly 303 to adjust the focus plane of standard microscope 301 until the image is in focus. Save image and x,y location data 1006 saves the image and its x and y position to computer datastore 504. Computer application 505 will then align image with boundaries and/or adjacent images 1007. Has slide boundary been reached 1008 determines if slide boundary 701 has been reached. If slide boundary 701 has not been reached, move along scan path by maximum scanning path step 1009 moves slide 104 along optimal scanning path 909. Steps 1003 through 1009 are repeated until slide boundary 701 is reached. Has end of slide been reached 1010, determines whether or not slide end 704 has been reached. If slide end 704 has not been reached, move along slide path parallel to boundary 1011 moves slide 104 to the next column of images along optimal scanning path 909 parallel to slide boundary 701 and steps 1003 through 1010 are repeated until slide end 704 is reached. Create composite image 1012 combines all of the images captured during the detailed scan into a single composite image. In one embodiment, step 1012 stiches images together. In another embodiment, step 1012 aligns images into a single image.

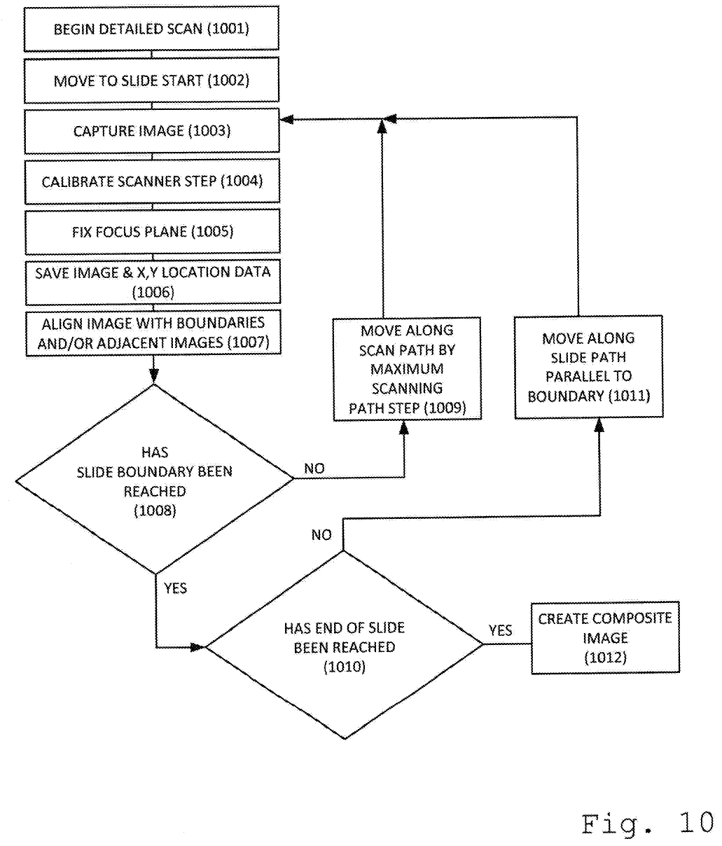

FIG. 11 illustrates a graphical user interface 1100 configured to control universal scanning stage 200 and display real time images of sample 705. In one embodiment, graphical user interface can be a part of computer application 505. In this embodiment, universal scanning stage 200 can be controlled by computer 305. In one embodiment, image data of sample 705 can be a video. In another embodiment, image data can be a still image.

In one embodiment, graphical user interface 1100 can comprise a focus control 1101, a fast scan button 1102, a detailed scan button 1103, a stop button 1104, a panning control 1105, capture image button 1106, a viewing area 1107, a thumbnail view 1108 a sample thumbnail 1109 and a user boundary 1110. Focus control 1101 allows a user to adjust the focus plane of standard microscope 101. In one embodiment, focus control 1101 can result in moving universal microscope stage 100 along its z-axis using third motor assembly 303.

Fast scan button 1102 can initiate a fast scan as described by fast scanning method block diagram 800. Detailed scan button 1103 can initiate a detailed scan as described by detailed scanning block diagram 1000. Stop button 1104 can end the current scan.

Panning control 1106 allows user to move slide 104 and can cause the image of sample 705 to move in display area 1107. In one embodiment, panning control 1106 can move the universal microscope stage 100. Capture image 1106 can capture an image of sample 705 as it is currently displayed in display area 1107. In one embodiment, this image is stored in computer datastore 504.

A thumbnail view 1108 can show the full slide as captured by fast scan 804. In one embodiment a user can use thumbnail view 1108 to move slide 104 and change the image show in display 1107. In one embodiment a thumbnail version 1109 of sample 705 can be displayed in thumbnail view 1108. In one embodiment, a user can define an area 1109. Area 1109 will set the outer boundaries of a detailed scan.

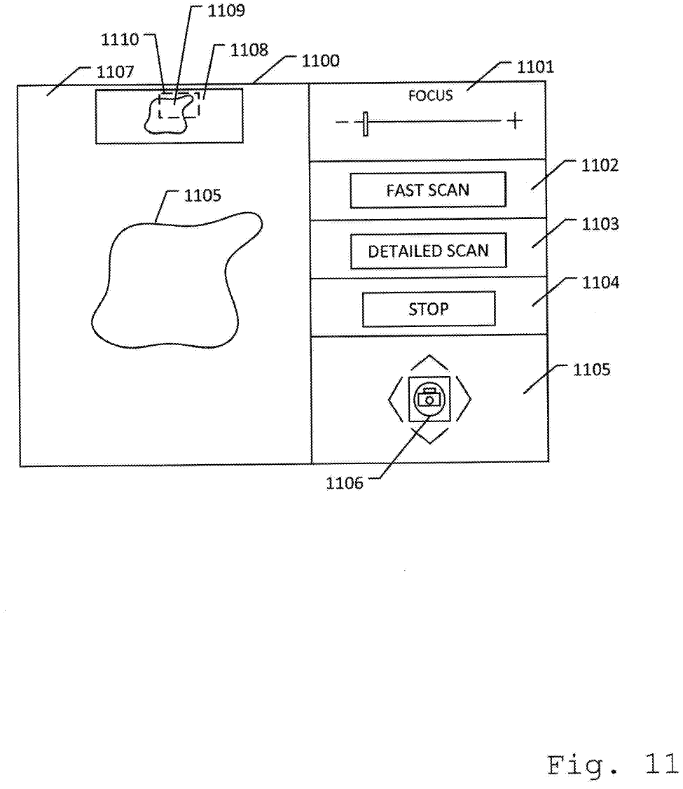

FIG. 12 illustrates a mobile device mount 1200. In one embodiment, mobile device mount 1200 can be comprised of a platform 1201, a mounting bracket 1202, a support bracket 1203, and a support bracket track 1206. Platform 1201 can be further comprised of a top surface 1201a, a proximal end 1201b, a distal end 1201c an opening 1201d, a bottom surface 1021e, a first wall 1201f, a second wall 1201g, a third wall 1201h and a fourth wall 1201j. Fourth wall 1201j can further comprise a clamping device orifice 1201k. In one embodiment, clamping device orifice 1201k can be threaded. Opening 1201d can be an opening on one proximal end 1201b of mobile device mount 1200. In one embodiment first wall 1201f can be angled in such a way that first wall 1201f can direct microscope eyepiece 201a to a particular location. Mounting bracket 1202 can be an adjustable bracket that can be fixed at any point up and down microscope mount 1202. Mounting bracket 1202 can move along one or more mounting bracket tracks 1204. In one embodiment, one mounting bracket track 1204 can extend along second wall 1201g and an additional mounting bracket track can extend along third wall 1201h. Mounting bracket 1202 can be moved using a clamping device 1205. In one embodiment, clamping device can further comprise a bolt 1205a and a wheel 1205b. Bolt 1205a can be spun using wheel 1205b. Mounting bracket 1202 can be wedged in such a way that microscope eyepiece 201a can be directed to a particular point. In one embodiment, support bracket 1203 can be fixable at any point along support bracket track 1204 using one or more set screws 1207. Support bracket 1202 can be fixed at any location along support bracket track 1204. Support bracket 1203 can used to support an object placed on mobile device mount 1200.

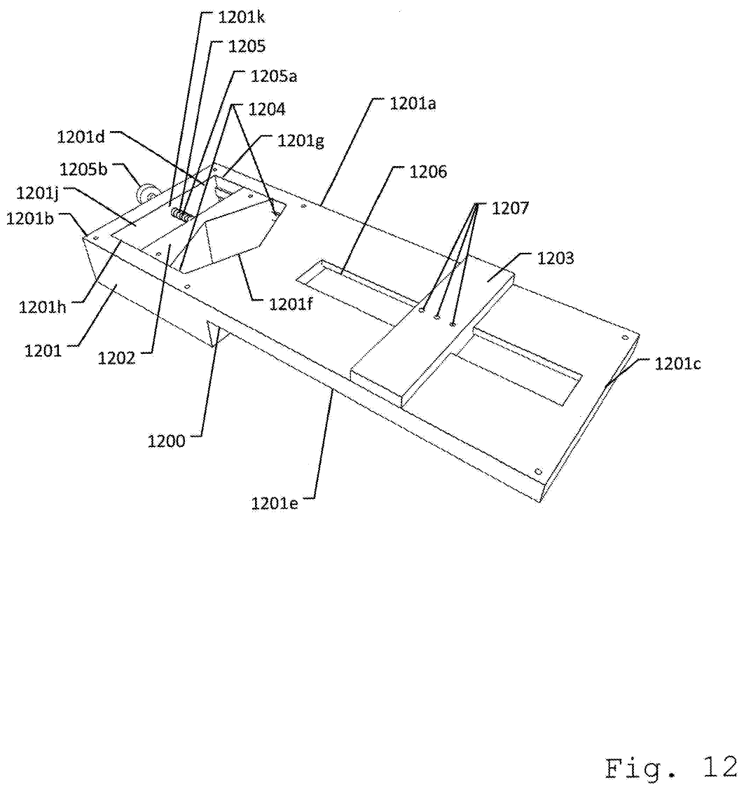

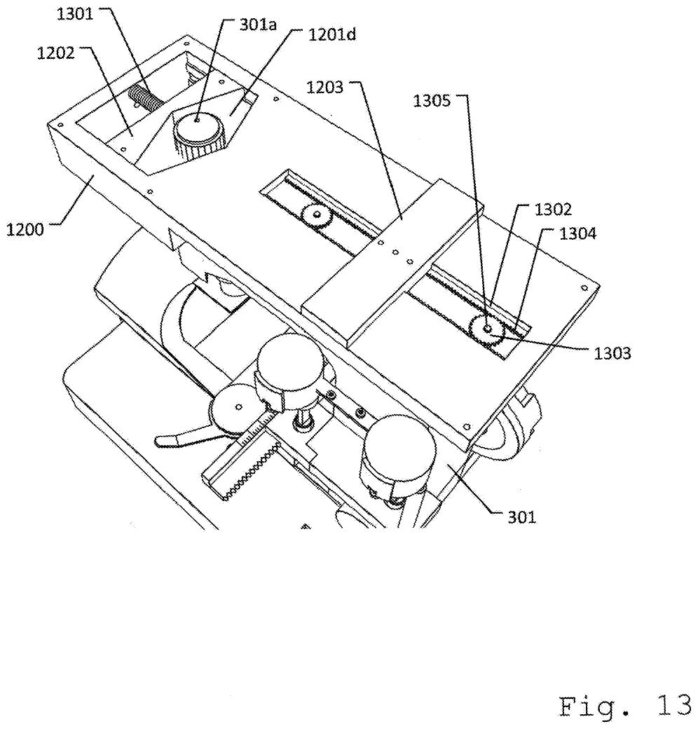

FIG. 13 illustrates mobile device mount 1200 being mounted on standard microscope 301. In one embodiment, microscope eyepiece 301a can be centered along the lower edge of microscope mount 1201 and mounting bracket 1202. Mounting bracket 1202 can be fixed using biasing device 1301 in such a way that microscope eyepiece 301a is held between microscope mount 1201 and mounting bracket 1202. In one embodiment, biasing device can be a spring. In one embodiment, mobile device mount 1200 can also be supported by standard microscope 301 using bottom surface 1201e. In one embodiment, support bracket 1203 can be positioned using support rack and pinion 1302. Support rack and pinion 1302 can further comprise a pinion gear 1303 mated with a rack 1304.

FIG. 14A illustrates a mobile device 1401. Mobile device 1401 can further comprise mobile device camera 1402 and screen 1403.

FIG. 14B illustrates mobile device mount 1200 mounted on standard microscope 301 being used to support mobile device 1401. Mobile device mount 1200 can be mounted on standard microscope 301. Mobile device 1401 can be horizontally positioned on mobile device mount 1200 so mobile device camera 1402 can be positioned over microscope eyepiece 301a so that slide 104 is visible on screen 1403. Support bracket 1203 can be fixed at a position along support bracket track 1204 can be vertically positioned on mobile device mount 1400 so that so that mobile device camera 1402 can be positioned over microscope eyepiece 301a so that slide 104 is visible on screen 1403.

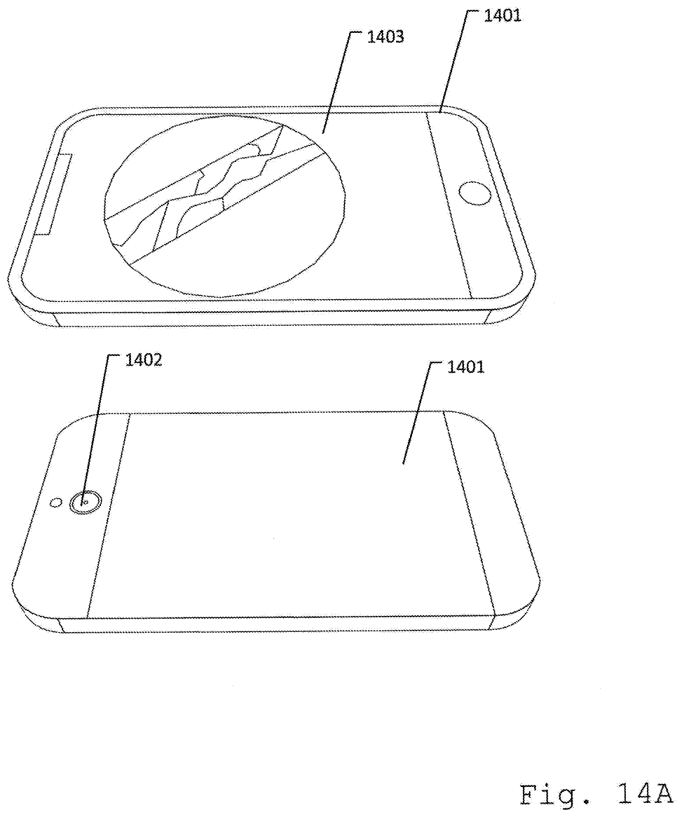

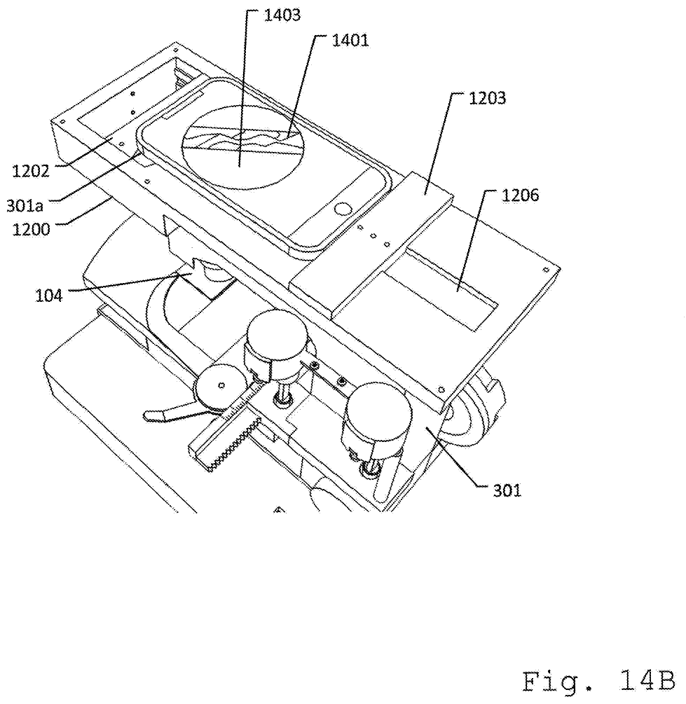

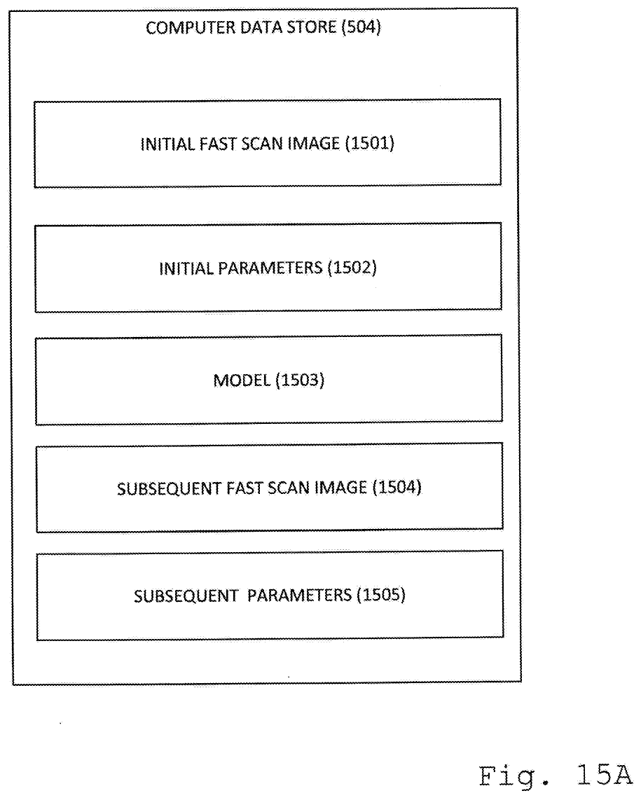

FIG. 15A illustrates an exemplary computer data store 504. Computer data store 504 can store one or more initial fast scan images 1501, one or more initial parameters 1502, a model 1503, one or more subsequent fast scan images 1504, and one or more subsequent parameters 1505.

FIG. 15B illustrates training model 1503. In one embodiment, a plurality of initial fast scan images 1501 can be interpreted by a pathologist to form a plurality of initial parameters 1502. A model 1503 can be developed using machine learning and linear regression techniques.

FIG. 15C illustrates feeding inputs into model 1503. In one embodiment, subsequent fast scan image 1504 can be fed into model 1503. Model 1503 can output subsequent parameters 1505. Universal scanner stage 200 can use subsequent parameters 1505 to produce region of interest scans 1506 and detailed scans 1507.

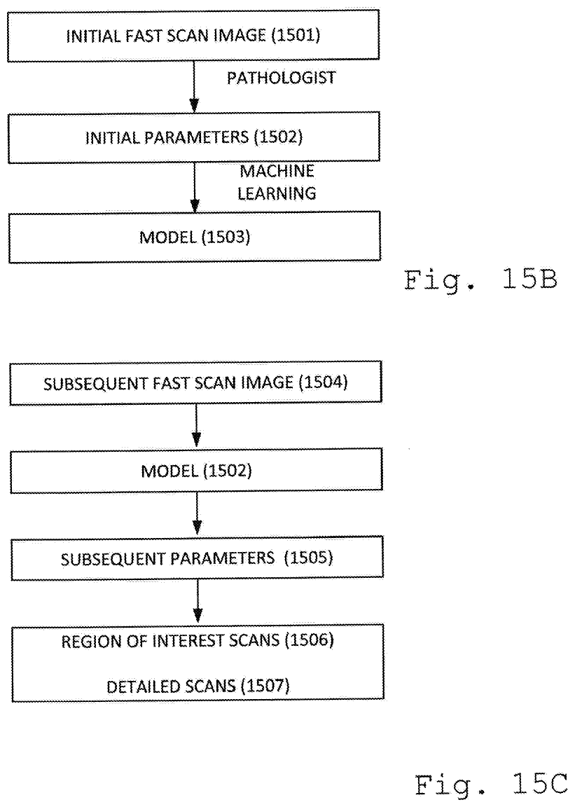

FIG. 16 illustrates initial parameters 1502. Initial parameters can further comprise scan boundaries 1601, magnification 1603, focal planes 1605, and slide movements 1604. In one embodiment, a user can set scan boundaries 1601 to be something inside of slide boundaries 701. Further a user can set the magnification 1603 of microscope 301 to a higher level when certain areas of sample 705 are being examined. Additionally, a user can adjust focal planes 1605 by using third motor assembly 303 to adjust the focus of microscope 303. Further, multiple images at different focus levels can be used to form focus stacked images. Finally, a user can direct slide movements 1604 while examining sample 705.

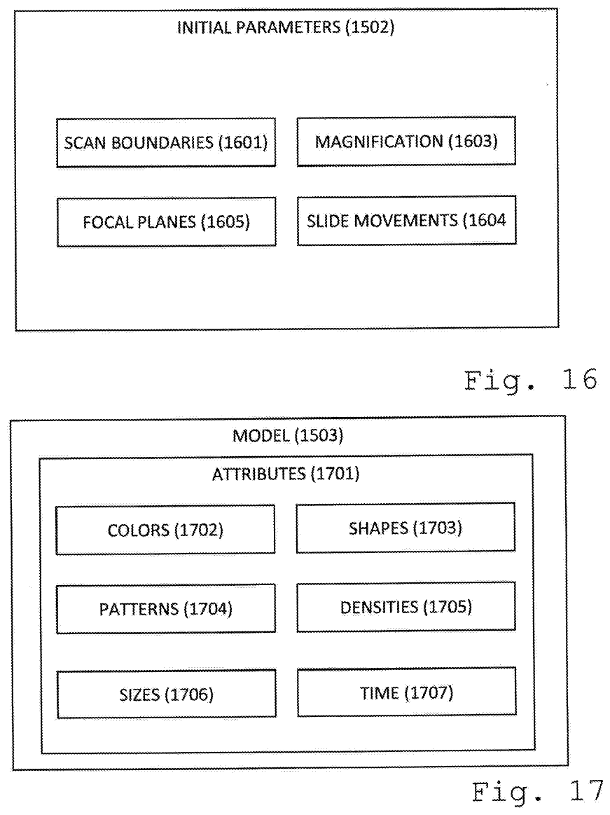

FIG. 17 illustrates model 1503 attributes 1701. Attributes 1701 can comprise colors 1702, shapes 1703, patterns 1704, densities 1705, sizes 1706, and time 1707. Colors 1702 can be colors of sample 705 that are of interest to a user. Further, shapes 1703 can be shapes of sample 705 that are of interest to a user. In one embodiment, shapes 1703 can be a shape that indicates a particular diagnosis to a user such as a pathologist. Densities 1705 can be the densities of sample 705. In one embodiment, sizes 1706 can be the size of sample 705. In another embodiment, sizes 1706 can be the size of certain structures of sample 705. Time 1707 can be the time a user spends analyzing a particular area of sample 705.

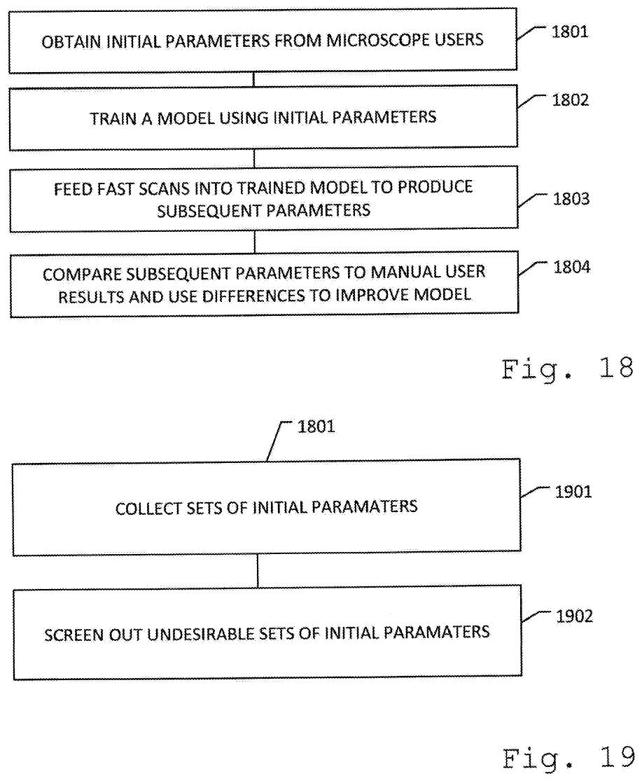

FIG. 18 illustrates an exemplary method for automating microscope scanning of samples 1800. A first step of method 1800, is to obtain initial parameters from microscope users 1801. In one embodiment, inputs can be gathered by recording video of user performing similar tasks using universal microscope stage 100. Videos can be recorded using camera 302. Additionally, the position of third motor assembly 303, first motor assembly 201 and second motor assembly 202 are during use are recorded in step 1800. Step 1802 of method 1800, can be to train model 1503 using initial parameters 1502. Next, step 1803 of method 1800 can be to feed fast scan images into trained model 1503 to produce subsequent parameters 1505. The final step of method 1800, step 1804, can be to compare subsequent parameters 1505 obtained from model 1503 to a manual user's results. The differences found can be used to improve model 1503.

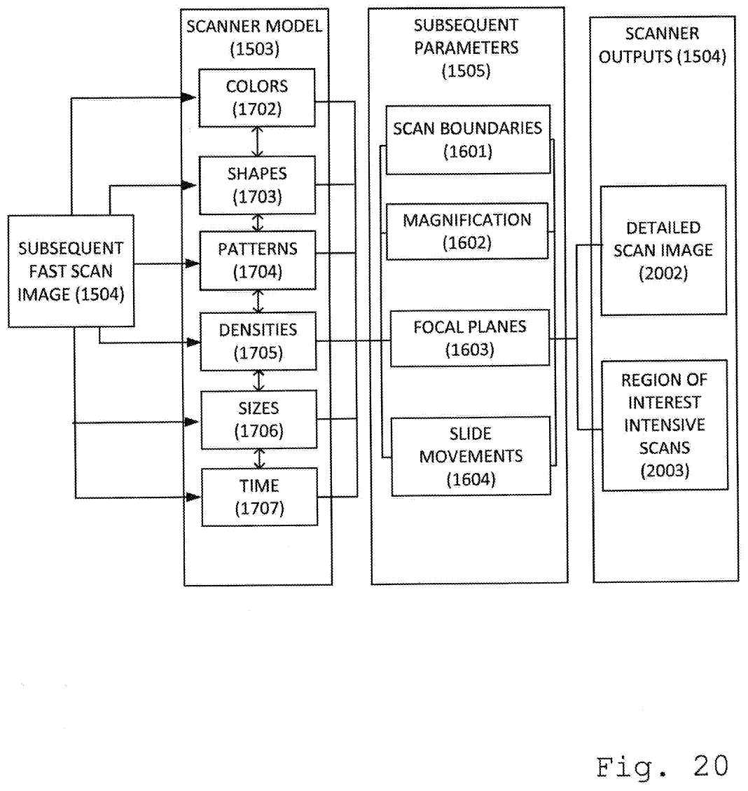

FIG. 19 illustrates a step, obtaining suitable sets of initial parameters 1502 to be used for training a model used automate microscope scanning of samples. First step 1801 of method 1800 can comprise two sub-steps, collect sets of user inputs 1901 and screening out undesirable sets of user inputs 1902. The first sub-step of step 1801 is to collect sets of initial parameters 1901. Each initial parameter 1502 can comprise can comprise scan boundaries 1601, magnification 1603, focal planes 1605 and slide movements 1604.

In the second sub-step 1902 of step 1801, initial parameters 1502 that do not produce desirable results are screened out of data sets. Some examples of undesirable results can be results from training sessions, untrained users, or calibration tests. These results would not result in a satisfactory subsequent parameters 1505 and therefore should be excluded from data sets.

FIG. 20 illustrates model 1503 processing subsequent fast scan images 1504 to produce subsequent parameters 1505. Subsequent parameters 1505 can be used to produce scanner outputs 1504 using universal scanning stage 200 and camera 302.

Subsequent fast scan images 1504 can be a new fast scan of sample 705 which can be input into model 1503. In one embodiment model 1503 can comprise attributes 1701. Attributes 1701 can further comprise:
a. colors 1702;
b. shapes 1703
c. patterns 1704;
d. densities 1705;
e. sizes 1706; and/or
f. time 1707.

Subsequent fast scan image 1504 can be fed into model 1503. Model 1503 can determine if colors of fast scan image 1504 resembles colors 1702. Model 1503 also can search subsequent fast scan image 1504 for shapes that are comparable to shapes 1703 that were of interest to previous users. Additionally, model 1503 can search subsequent fast scan image 1504 for patterns 1704 that are similar to patterns from subsequent fast scan image 1504 of similar to patterns that were of interest to previous users. Model 1505 can also compare sizes 1706 in subsequent fast scan image 1504 to that of initial fast scan images 1501. Finally, model 1503 can use time 1707 spent by previous users viewing particular areas of sample 705 to look for other important areas.

Model 1503 can produce subsequent parameters 1505 for a subsequent fast scan image. Subsequent parameters can comprise scan boundaries 1601, magnification 1602, focal planes 1603, and slide movements 1604. Subsequent parameters 1505 can be used to produce scanner outputs 1504. Scanner outputs 1504 can comprise detailed scan image 2002 and regions of interest intensive scans 2003. Detailed scan image 2002 can be produced using method 1000. In one embodiment detailed scan image 2002 can be use scan boundaries 1601 to reduce the area of slide 104 that is scanned. Region of interest intensive scans 2003 are scans of certain areas of slide 104. Region of interest intensive scans 2003 can have specific scan boundaries 1601, include multiple magnifications 1602, and focal planes 1603.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A universal microscope stage comprising:
a slide holder capable of holding a slide in a fixed position relative to said slide holder;
a base mount comprising a plurality of mounting orifices aligned across said base mount;
a first rack mounted to said base mount;
a first driver comprising a first pinion orifice; and
a first pinion extending through said first pinion orifice, said first pinion interfacing with said first rack such that when said first pinion rotates, said first driver moves said slide holder along a first axis relative to said base mount.

2. The universal microscope stage of claim 1 further comprising:
a second rack mounted to said slide holder;
a second driver comprising a second pinion orifice; and
a second pinion extending through said second pinion orifice, said second pinion interfacing with said second rack such that when said second pinion rotates, said second driver moves said slide holder along a second axis relative to said base mount.

3. The universal microscope stage of claim 2 wherein said first driver is connected with said second driver.

4. The universal microscope stage of claim 3 further wherein said first driver and said second driver are unibody.

5. The universal microscope stage of claim 2 further wherein said first pinion further comprises a first pinion shaft and a first pinion gear; and wherein said second pinion further comprises a second pinion shaft and a second pinion gear.

6. The universal microscope stage of claim 5 further comprising:
a first motor coupled with said first pinion shaft;
a second motor coupled with said second pinion shaft;
a bracket connecting said first motor with said second motor;
wherein said bracket further comprising a bracket first end and a bracket second end; and
said bracket first end connected to said first motor and said bracket second end connected to said second motor, such that said first motor remains fixed relative to said second motor while said first motor rotates said first pinon, further wherein said second motor remains fixed relative to said first motor while said second motor rotates said second pinion.

7. The universal microscope stage of claim 6 further comprising a motor mount, said motor mount further comprising a first end and second end, wherein said first end connects to said first driver and said second end connects to said first motor.

8. A universal microscope stage comprising:
a slide holder capable of holding a slide in a fixed position relative to said slide holder;
a base mount comprising a proximal base mount end, a distal base mount end and a mounting orifice;
said mounting orifice greatly extends from said proximal base mount end to said distal base mount end;
a first rack mounted to said base mount;
a first driver comprising a first pinion orifice; and
a first pinion extending through said first pinion orifice, said first pinion interfacing with said first rack such that when said first pinion rotates, said first driver moves said slide holder along a first axis relative to said base mount.

9. The universal microscope stage of claim 8 further comprising:
a second rack mounted to said slide holder;
a second driver comprising a second pinion orifice; and
a second pinion extending through said second pinion orifice, said second pinion interfacing with said second rack such that when said second pinion rotates, said second driver moves said slide holder along a second axis relative to said base mount.

10. The universal microscope stage of claim 9 wherein said first driver is connected with said second driver.

11. The universal microscope stage of claim 10 further wherein said first driver and said second driver are unibody.

12. The universal microscope stage of claim 9 further wherein said first pinion further comprises a first pinion shaft and a first pinion gear; and wherein said second pinion further comprises a second pinion shaft and a second pinion gear.

13. The universal microscope stage of claim 12 further comprising:
a first motor coupled with said first pinion shaft;
a second motor coupled with said second pinion shaft;
a bracket connecting said first motor with said second motor;
wherein said bracket further comprising a bracket first end and a bracket second end; and
said bracket first end connected to said first motor and said bracket second end connected to said second motor, such that said first motor remains fixed relative to said second motor while said first motor rotates said first pinon, further wherein said second motor remains fixed relative to said first motor while said second motor rotates said second pinion.

14. The universal microscope stage of claim 13 further comprising a motor mount, said motor mount further comprising a first end and second end, wherein said first end connects to said first driver and said second end connects to said first motor.

15. The universal microscope stage of claim 8 further comprising a mounting bolt mountable anywhere along said orifice.
